(19) United States
(12) Patent Application Publication
(10) Pub. No.: US 2013/0134909 A1
(43) Pub. Date: May 30, 2013

(54) HUB POWER DEVICE OF A HYBRID VEHICLE

(71) Applicant: Hung-Fu LEE, New Taipei City (TW)

(72) Inventor: Hung-Fu LEE, New Taipei City (TW)

(21) Appl. No.: 13/723,483

(22) Filed: Dec. 21, 2012

Related U.S. Application Data
(63) Continuation-in-part of application No. 12/621,900, filed on Nov. 19, 2009, now abandoned.

(51) Int. Cl. H02K 7/00; H02P 6/16; H02P 3/14

(52) U.S. Cl. CPC H02K 7/006; H02P 3/14; H02P 6/16
USPC 318/139; 310/67 R; 318/376; 318/490

(57) ABSTRACT

A hub power device of a hybrid vehicle, comprising a motor powered battery, an accelerator unit, a motor control unit, an annular stator, and an axle shaft which passes through the annular stator to be combined with a hub. An inner wall of the hub is fixed with an annular rotor which is movably sheathed on an outer rim of the annular stator. When the accelerator unit is activated, the motor control unit controls the motor powered battery to supply electricity to the annular stator and the annular rotor, thereby driving the hub to spin. If the accelerator unit is inactivated, the motor powered battery stops supplying electricity to the annular stator and the annular rotor, allowing the annular rotor to spin freely following the hub, thereby generating electric energy between the annular stator and the annular rotor and charging the motor powered battery to reduce fuel consumption.

### RELATED APPLICATION

This application is a Continuation-In-Part of currently pending U.S. patent application Ser. No. 12/621,900 filed on 2009 Nov. 19.

### BACKGROUND OF THE INVENTION

a) Field of the Invention

The present invention relates to a hub power device of a hybrid vehicle, and more particularly to a device that is disposed in a hub and uses motor power to assist an engine to drive an axle shaft to spin, as well as serves as a DC (Direct Current) brushless cascade motor for aiding engine power.

b) Description of the Prior Art

It is well known that conventional cars and motorcycles consume a lot of energy and are also a primary source of carbon dioxide emission. However, as it is currently unable to replace all the conventional vehicles in a short time, the hybrid system has become a focus that is paid attention to by vehicle industries and environmental protection groups.

The biggest difference between the conventional hybrid system and the conventional engine transmission system lies in that the existing hybrid system is integrated with an electric motor, an automatic engine start and stop device and an engine transmission system. When a vehicle starts up, an on-board engine is turned off first and is driven completely by the electric motor. Next, when the vehicle accelerates, the engine will then be activated to provide acceleration to the vehicle.

As the structure of the existing hybrid system is very much different from that of the conventional engine system, it is apparently inappropriate to allow the conventional vehicle to produce hybrid power output by modifying the hybrid system and the conventional engine. Therefore, if a consumer needs to replace his or her conventional engine transmission vehicle with a hybrid vehicle, he or she has to spend a lot of money. Moreover, the vehicle industries cannot manufacture the required hybrid vehicles in a short time. Thus, the hybrid vehicle is not promoted as expected.

In addition, the existing hybrid system uses primarily an electric motor with a strong permanent magnet. Nevertheless, magnetic force of the permanent magnet will be degraded as time of use and lines of magnetic force will be reduced as temperature rises. In a mean time, there is also an issue of magnetic leakage. Therefore, for the motor using the permanent magnet, the permanent magnet has to be enclosed entirely; otherwise, if the lines of magnetic force leak out, magnetic objects (such as iron nails, iron objects, magnetic substances in dirt) on a road will be attracted easily to damage the motor. On the other hand, rare earth, such as iron, nickel and cobalt, that is used to make the permanent magnet, gets more expensive; hence, it is difficult to lower down the production cost.

### SUMMARY OF THE INVENTION

The primary object of the present invention is to provide a device that is disposed in an axle shaft and uses motor power to assist an engine to drive the axle shaft to spin, in order to overcome the abovementioned problems of prior arts.

To achieve the abovementioned object, a hub power device of a hybrid vehicle, according to the present invention includes:

a motor powered battery that is disposed in a vehicle body, with that an accelerator unit disposed in the vehicle receives a driver's operations to generate an accelerator signal;

an annular stator that is provided with a stator ring and plural stator coils wound on the stator ring, with that the stator ring is fixed on the vehicle body, an axle shaft of the vehicle passes through the stator ring to be combined with a hub, and the stator ring is disposed in the hub;

an annular rotor that is provided with a rotor ring and plural rotor coils wound on the rotor ring, with that the rotor ring is fixed on an inner wall of the hub and is movably sheathed on an outer rim of the stator ring; and

a motor control unit that is disposed in the vehicle body and connects electrically the said motor powered battery, accelerator unit and stator coils.

The motor control unit can receive the accelerator signal to control the motor powered battery to supply electric energy to the annular stator, so that the hub can spin following the annular rotor that is driven by the annular stator. In addition, if the accelerator unit does not generate the accelerator signal and the annular rotor spins following the hub, electric energy will be generated between the said annular rotor and annular stator; whereas, the motor control unit will control the electric energy of the annular stator to charge the motor powered battery.

According to the abovementioned primary structure characteristics, the stator ring is made by silicon steel (or other high magnetic material) and is provided with a stator ring hole; whereas, the stator coils are wound alternately on the stator ring. The rotor ring is also made by silicon steel and is provided with a rotor ring hole. The rotor coils are wound alternately on the rotor ring and the stator ring is disposed in the rotor ring hole.

According to the abovementioned primary structure characteristics, the annular stator is provided with a stator coupling coil that connects electrically the said stator coils, and the stator coupling coil is wound on the stator ring. The annular rotor is provided with a rotor coupling coil that connects electrically the said rotor coils, and the rotor coupling coil is wound on the rotor ring, at a location corresponding to the stator coupling coil. Electric energy on the annular stator and the annular rotor is coupled together through the said stator coupling coil and rotor coupling coil. The said annular stator and annular rotor constitute a DC brushless cascade motor.

According to the abovementioned primary structure characteristics, the vehicle is an automobile or a motorcycle, whereas the stator ring is fixed on an on-board brake system and is disposed on the vehicle body.

According to the abovementioned primary structure characteristics, the motor control unit connects electrically an on-board brake unit. The brake unit links to the on-board brake system and receives a driver's operations to generate a brake signal. The motor control unit receives the brake signal to control the motor powered battery to stop supplying electric energy to the annular stator, allowing the annular rotor to spin by inertia following the hub, so that electric energy can be generated between the said annular rotor and annular stator. Furthermore, the motor control unit controls the electric energy of the annular stator to charge the motor powered battery.

According to the abovementioned primary structure characteristics, the motor control unit connects electrically an on-board gear position unit. The gear position unit links to an on-board transmission and receives a driver's operations to generate a gear position signal containing data of P gear, R gear, N gear or D gear. The motor control unit receives the gear position signal and controls the motor powered battery to stop supplying electric energy to the annular stator, allowing the annular rotor to spin by inertia following the hub, so that electric energy can be generated between the annular rotor and the annular stator, when the gear position signal contains the data of P gear, R gear or N gear. On the other hand, the motor control unit controls electric energy of the annular stator to charge the motor powered battery and controls the motor powered battery to supply electric energy to the annular stator, so that the hub can spin following the annular rotor that is driven by the annular stator on the vehicle body, when the gear position signal contains the data of D gear.

According to the abovementioned primary structure characteristics, the motor control unit connects electrically an on-board diagnostic system. The diagnostic system monitors a status of an on-board engine to generate a diagnostic signal. The motor control unit receives the diagnostic signal to determine when to turn on or off the motor powered battery to supply electric energy to the annular stator.

According to the abovementioned primary structure characteristics, the motor control unit connects electrically a detection unit that is disposed on the annular stator. The detection unit is used to detect an angle of the rotor and current of the coils. The detection unit detects the annular stator to generate a detection signal that includes the angle of the rotor and the current of the coils. In addition, the motor control unit receives the detection signal to determine when to turn on or off the motor powered battery to supply electric energy to the annular stator.

According to the abovementioned primary structure characteristics, the motor control unit includes a motor controller that connects electrically the accelerator unit, and a motor power controller that connects electrically the said motor controller, motor powered battery and stator coils, so that when the motor controller receives the accelerator signal, the motor power controller can control the motor powered battery to supply electric energy to the annular stator.

According to the abovementioned primary structure characteristics, the motor control unit includes a motor kinetic energy retriever that connects electrically the said motor controller, motor powered battery and stator coils, so that if the motor controller does not receive the accelerator signal, the motor kinetic energy retriever can control electric energy of the annular stator to charge the motor powered battery.

According to the abovementioned primary structure characteristics, the motor control unit includes a motor powered battery boost charger that connects electrically the said motor controller and motor powered battery. The motor powered battery boost charger connects electrically an on-board battery which connects electrically an on-board generator, so that while the motor powered battery supplies electric energy to the annular stator, the motor powered boost charger will boost up electric energy of the on-board battery and charge the motor powered battery.

In comparison with the prior arts, the present invention is actually provided with following advantages:
1. Under an integrated operation of the motor control unit, when the accelerator unit is activated, electric energy will be outputted from the motor powered battery to the annular stator and the electric energy is used to drive the annular rotor which makes the hub and a wheel to spin, thereby aiding the engine to drive the wheel to spin, which further reduces fuel consumption or drives the annular rotor to make the hub and the wheel to spin only by electric energy under a low speed driving condition;
2. When the vehicle slides or brakes to decelerate, the motor powered battery can stop supplying electric energy to the annular stator and can input electric energy generated by inertia energy of the annular rotor that spins following the hub, to the motor powered battery for storage, thereby achieving the effect of recycling energy;
3. By the design of the said motor powered battery, annular stator, annular rotor and motor control unit, it only needs to modify the axle shaft of a conventional engine transmission vehicle that the hub can be driven to spin by electric energy of the motor powered battery, after replacing with the hub that is provided with the annular rotor and integrating with the motor control unit.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic cutaway view of a preferred embodiment of the present invention.

FIG. 2 shows a three-dimensional exploded view of the embodiment as shown in FIG. 1.

FIG. 3 shows another three-dimensional exploded view of the embodiment as shown in FIG. 1.

FIG. 4 shows a functional block diagram of the embodiment as shown in FIG. 1.

FIG. 5 shows another functional block diagram of the embodiment as shown in FIG. 1.

### DETAILED DESCRIPTION OF THE PREFERRED EMBODIMENTS

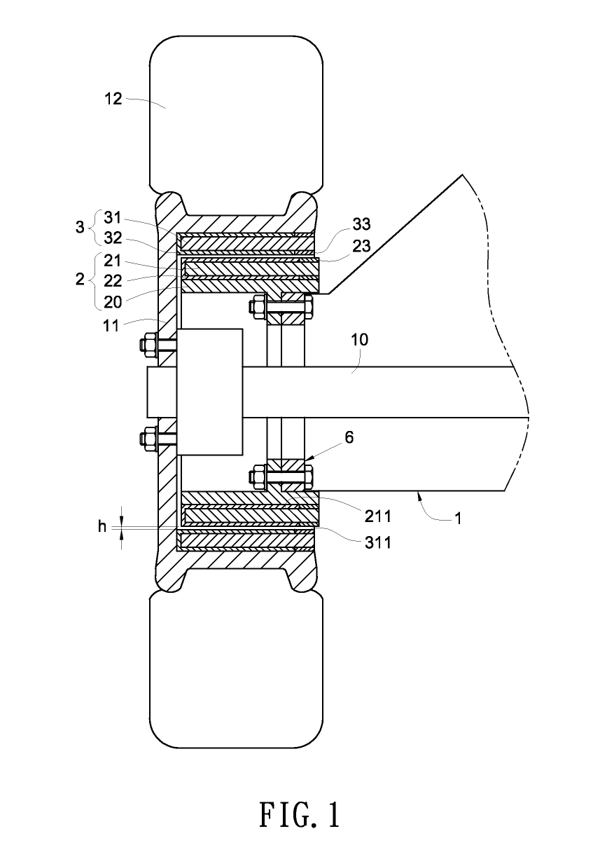

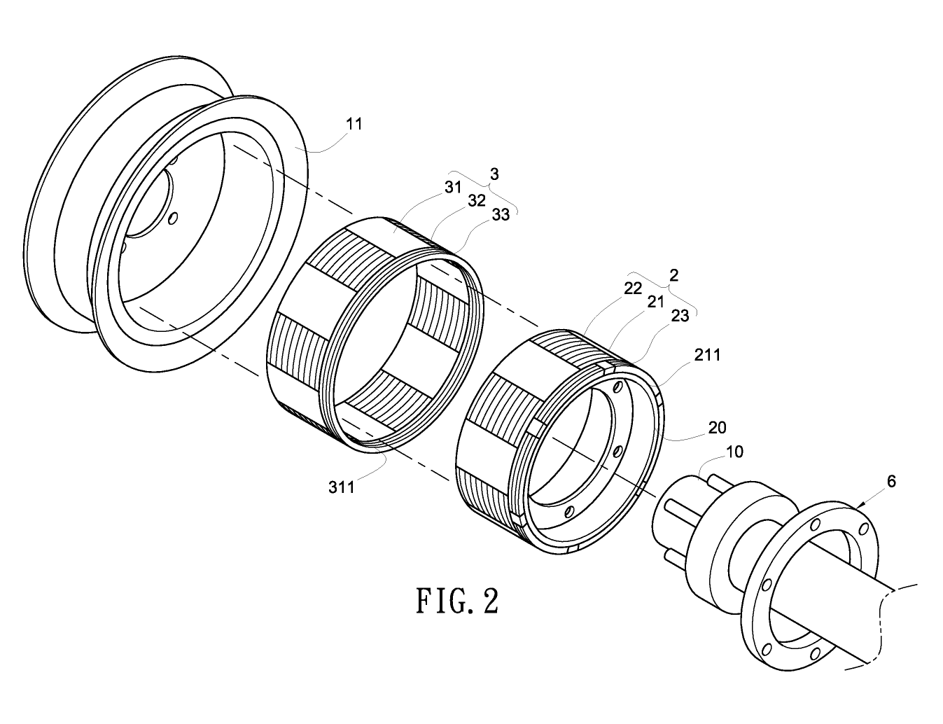

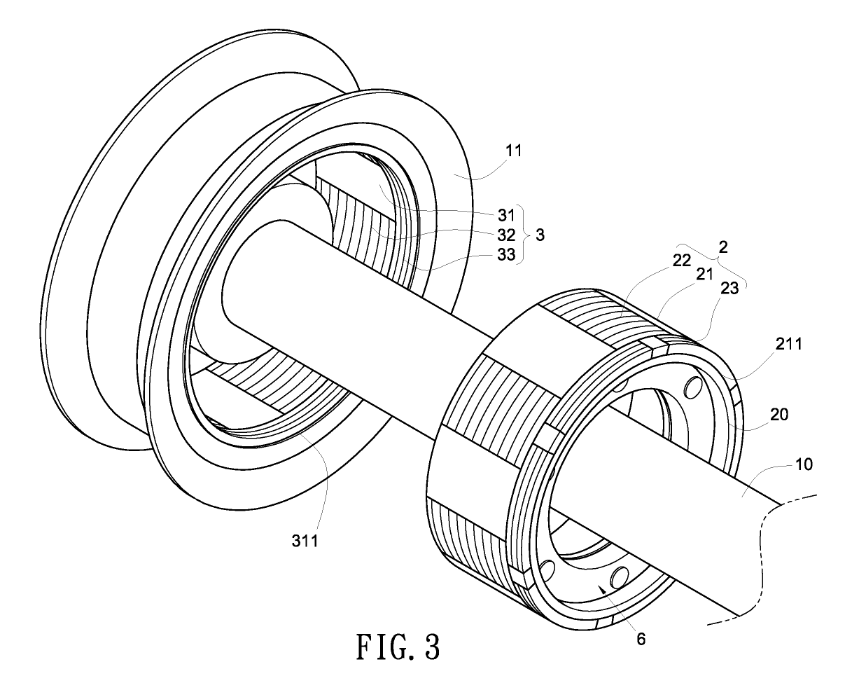

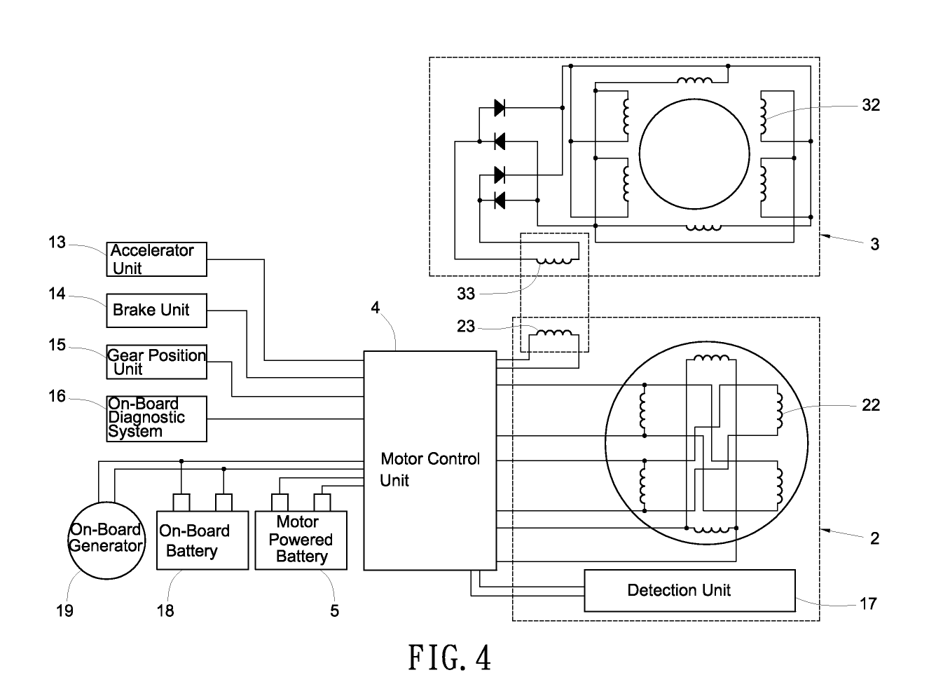

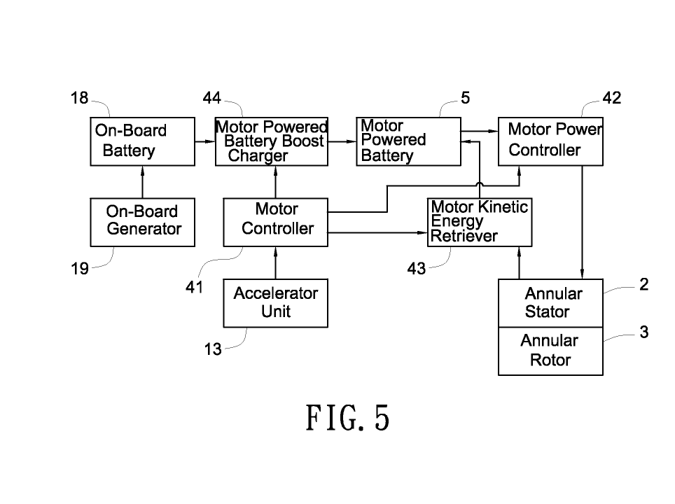

Referring to FIG. 1, it shows a schematic cutaway view of a preferred embodiment of the present invention. Also as shown in the drawings of FIGS. 2 to 5, the present invention discloses a hub power device of a hybrid vehicle, comprising a 48V (or other voltage) of motor powered battery 5, an annular stator 2, an annular rotor 3 and a motor control unit 4.

The motor powered battery 5 is disposed in a vehicle body 1 and the vehicle can be an automobile or a motorcycle; however, the present invention is implemented by the automobile which includes an on-board accelerator unit 13 with an accelerator pedal, with that the accelerator pedal receives a driver's operations to generate an accelerator signal.

The annular stator 2 is provided with a stator ring 21 and plural stator coils 22 wound on the stator ring 21. The stator ring 21 is sheathed on a stator frame 20 and is fixed on the vehicle body 1 through the stator frame 20. An axle shaft 10 passes through the stator ring 21 to be combined with a hub 11, an outer wall of the hub 11 is sheathed with a wheel 12, and the stator ring 21 is disposed in the hub 11. In addition, the stator ring 21 can be also fixed in an on-board brake system 6 and is disposed on the vehicle body 1.

The annular rotor 3 is provided with a rotor ring 31 and plural rotor coils 32 wound on the rotor ring 31, an inner wall of the hub 11 is fixed with the rotor ring 31 which is movably sheathed on an outer rim of the stator ring 21. Furthermore, there is a gap h between an inner wall of the rotor ring 31 and an outer wall of the stator ring 21 for rotation of the annular rotor 3.

The motor control unit 4 is disposed in the vehicle body 1 and connects electrically the said motor powered battery 5, accelerator unit 13 and stator coils 22. The motor control unit 4 receives the accelerator signal to control the motor powered battery 5 to supply electric energy to the annular stator 2, generating a magnetic field between the annular stator 2 and the annular rotor 3, which drives the hub 11 to spin following the annular rotor 3 driven by the annular stator 2 on the vehicle body 1.

If the accelerator unit 13 does not generate the accelerator signal and the annular rotor 3 spins following the hub 11, a magnetic field is still generated between the annular rotor 3 and the annular stator 2 to output electric energy; whereas, the motor control unit 4 controls the annular stator 2 to output electric energy to charge the motor powered battery 5.

Furthermore, for more specific implementation, the stator ring 21 is made by annular silicon steel and is provided with a stator ring hole 211. The rotor ring 31 is also made by annular silicon steel and is provided with a rotor ring hole 311. The rotor coils 32 are wound alternately on the rotor ring 31, and the stator ring 21 is disposed in the rotor ring hole 311.

The annular stator 2 is provided with a stator coupling coil 23 which connects electrically the stator coils 22, and the stator coupling coil 23 is wound on a side of the stator ring 21. The annular rotor 3 is provided with a rotor coupling coil 33 which connects electrically the rotor coils 32, and the rotor coupling coil 33 is wound on a side of the rotor ring 31, at a location corresponding to the stator coupling coil 23. Electric energy on the annular stator 2 and the annular rotor 3 is coupled together through the stator coupling coil 23 and the rotor coupling coil 33. The annular stator 2 and the annular rotor 3 constitute a DC brushless cascade motor.

A conventional cascade motor is the most powerful one among all kinds of motors. However, the cascade motor needs to use carbon brushes to transmit electric energy to a rotor, which is less durable. The annular stator 2 and the annular rotor 3 disclosed by the present invention are provided with a same working principle as that of the cascade motor, and electric energy is coupled together through the said stator coupling coil 23 and rotor coupling coil 33; therefore, there is no need to use the carbon brushes. In addition, the conventional cascade motor cannot be used as a generator. However, the annular stator 2 and the annular rotor 3 disclosed by the present invention can generate electricity using power from spinning of the hub 11 by inertia.

The function of the said stator coils 22 and rotor coils 32 is to produce magnetic force, and the function of the said stator coupling coil 23 and rotor coupling coil 33 is coupling, so that electric energy in the annular stator 2 can be coupled with the annular rotor 3, acting like a transformer.

In a specific implementation, the motor control unit 4 connects electrically an on-board brake unit 14 which links to an on-board brake system 6. The brake unit 14 is provided with a brake pedal which receives a driver's operations to generate a brake signal. After receiving the brake signal, the motor control unit 4 controls the motor powered battery 5 to stop supplying electric energy to the annular stator 2, allowing the annular rotor 3 to spin by inertia following the hub 11, so that electric energy can be generated between the annular rotor 3 and the annular stator 2, and the motor control unit 4 can control the electric energy of the annular stator 2 to charge the motor powered battery 5.

The motor control unit 4 connects electrically an on-board gear position unit 15 which links to an on-board transmission. The gear position unit 15 is provided with a shift lever which receives a driver's operations to generate a gear position signal containing data of P gear, R gear, N gear or D gear. The P gear is a parking gear, the R gear is a reverse gear, the N gear is a neutral gear and the D gear is a driving gear.

The motor control unit 4 receives the gear position signal and controls the motor powered battery 5 to stop supplying electric energy to the annular stator 2 when the gear position signal contains the data of P gear, R gear or N gear, allowing the annular rotor 3 to spin by inertia following the hub 11, so that electric energy can be generated between the annular rotor 3 and the annular stator 2, and the motor control unit 4 can control the electric energy of the annular stator 2 to charge the motor powered battery 5. When the gear position signal contains the data of D gear, the motor control unit 4 can control the motor powered battery 5 to supply electric energy to the annular stator 2, so that the hub 11 can spin by inertia following the annular rotor 3 which is driven by the annular stator 2 on the vehicle body 1.

The motor control unit 4 connects electrically an OBD2 (On-Board Diagnostic System 2) 16 which is able to monitor a status of the engine to generate a diagnostic signal. The motor control unit 4 can receive the diagnostic signal to determine when to turn on or off the motor powered battery 5 to supply electric energy to the annular stator 2.

The OBD2 primarily monitors discharge of waste gas and an engine efficiency, so that a warning can be sent out to a driver for maintenance in an auto shop when there is an anomaly, which prevents causing more pollution under a condition that the driver is not aware of. The angle of the accelerator pedal can be also accessed from the OBD2, and this information is a basis for controlling an angle of a throttle. Therefore, the angle of the accelerator pedal can be utilized by the motor control unit 4 as a basis of power output of the annular stator 2 and the annular rotor 3. In a mean time, the angle of the accelerator pedal can be also used to control engine output.

The motor control unit 4 connects electrically a detection unit 17 that is disposed on the annular stator 2. The detection unit 17 is used to detect an angle of the rotor and current of the coils. The detection unit 17 detects the annular stator 2 to generate a detection signal containing the angle of the rotor and the current of the coils; whereas, the motor control unit 4 can receive the detection signal to determine when to turn on or off the motor powered battery 5 to supply electric energy to the annular stator 2.

The motor control unit 4 includes a motor controller 41 which connects electrically the accelerator unit 13, and a motor power controller 42 which connects electrically the motor controller 41, the motor powered battery 5 and the stator coils 22. When the motor controller 41 receives the accelerator signal, the motor power controller 42 controls the motor powered battery 5 to supply electric energy to the stator coils 22 of the annular stator 2.

The motor control unit 4 includes a motor kinetic energy retriever 43 which connects electrically the motor controller 41, the motor powered battery 5 and the stator coils 22. If the motor controller 41 does not receive the accelerator signal, the motor kinetic energy retriever 43 can control the electric energy of the annular stator 2 to charge the motor powered battery 5.

The motor control unit 4 includes a motor powered battery boost charger 44 which connects electrically the motor controller 41 and the motor powered battery 5. The motor powered battery boost charger 44 connects electrically a 12V of on-board battery 18 which links to an on-board generator 19. The on-board generator 19 can charge the on-board battery 18. While the motor powered battery 5 supplies electric energy to the annular stator 2, the motor controller 41 enables the motor powered battery boost charger 44 boosts up the on-board battery 18 and charges the motor powered battery 5.

By the abovementioned components, when the shift lever moves to the P gear, R gear or N gear to slow down the vehicle, the accelerator unit 13 will not generate the accelerator signal and the annular rotor 3 will spin following the hub 11, so that electric energy can be generated between the annular rotor 3 and the annular stator 2, and the motor control unit 4 can control the electric energy of the annular stator 2 to charge the motor powered battery 5. Therefore, when the vehicle is driving down a hill or the accelerator pedal is released, the annular rotor 3 and the annular stator 2 will be changed into a powerful generator, storing the electric energy that is generated by inertia energy of spinning of the hub 11 into the motor powered battery 5.

The inertia energy of the spinning of the hub 11 includes kinetic energy when the engine is idle, kinetic energy when the vehicle slides and kinetic energy when the vehicle brakes.

When the shift lever moves to the D gear and the driver steps on the accelerator pedal to speed up the vehicle, the motor control unit 4 will receive the accelerator signal to control the motor powered battery 5 to supply electric energy to the annular stator 2, so that the hub 11 can spin following the annular rotor 3 that is driven by the annular stator 2 on the vehicle 1, thereby aiding the engine to drive the wheel 12 to rotate. Furthermore, the annular stator 2, the driving of the hub 11 by the annular rotor 3, as well as horse power output, adjustment of torsion and direction of spinning of the wheel 12, are all controlled by the motor control unit 4.

When the accelerator pedal is stepped down, power outputted by the annular rotor 3 and the annular stator 2 will be larger than engine power; therefore, the angle of the accelerator pedal does not need to be very large in order to save fuel consumption.

In the present invention, the original engine is modified and added by the annular rotor 3 and the annular stator 2 in the hub 11. These two components operate completely independent of each other. The power outputted by the annular rotor 3 and the annular stator 2 is also controlled by the stepping angle of the accelerator pedal; whereas, the annular rotor 3 and the annular stator 2 output power earlier than the engine. In other words, when the vehicle drives in low speed, the annular rotor 3 and the annular stator 2 can push the engine running, and therefore, the engine output will be reduced, thereby achieving the purpose of saving fuel. On the other hand, when the vehicle drives in high speed, the engine output will be larger than the power output of the annular rotor 3 and the annular stator 2, and the annular rotor 3 and the annular stator 2 will be under a free run condition, thereby reducing resistance to the engine.

When the accelerator pedal is released, the vehicle is in an idle mode. At this time, the motor power controller 42 will be turned off to become a high impedance status to avoid the magneto-resistance effect. In addition, the motor kinetic energy retriever 43 will be turned on to partially refill the electric energy that is generated by inertia of the annular rotor 3 and the annular stator 2 to the motor powered battery 5.

When the accelerator pedal is released and the brake pedal is stepped down, the vehicle is in an idle mode. At this time, the motor power controller 42 will be turned off to become a high impedance status to avoid the magneto-resistance effect. In addition, the motor kinetic energy retriever 43 will be turned on to refill the electric energy that is generated by inertia of the annular rotor 3 and the annular stator 2 to the motor powered battery 5. The power of this retrieved kinetic energy will be controlled by the angle of the brake pedal.

If the vehicle is not driving, the annular rotor 3 and the annular stator 2 will not be able to generate electricity. At this time, the motor controller 41 will turn on the motor powered battery boost charger 44 to boost up to 48V (or other voltage) from 12V and to charge the motor powered battery 5.

On the other hand, the present invention is designed to be with minimum modification and easy installation to achieve the purpose of saving fuel for the hybrid vehicle. The steps of adapting the hub power device into the conventional engine transmission vehicle are:

Step 1: removing an original brake caliper of a rear wheel and replacing with the annular stator 2;

Step 2: replacing a hub 11 used for an original vehicle 12 with the hub 11 that is installed with the annular rotor 3;

Step 3: fixing the motor control unit 4 and the motor powered battery 5 in the vehicle body and connecting electrically the motor control unit 4, the motor powered battery 5, the accelerator unit 13 and the stator coils 22;

Step 4: connecting electrically the motor control unit 4 to the OBD2; and

Step 5: connecting electrically the motor control unit 4 to the on-board battery 18.

By the abovementioned steps, it only needs to modify the axle shaft 10 of a conventional engine transmission vehicle and the modification can be accomplished by the easiest way after replacing with the hub 11 and integrating with the motor control unit 4.

The annular rotor 3 and the annular stator 2 of the present invention use the advantage that magnetic force of an electromagnet will not be aging; whereas, the magnetic force of the annular rotor 3 and the annular stator 2 is gained by lines of magnetic force resulted from electric energy, with that the magnitude and polarity of the electric energy can be controlled. Therefore, it facilitates controlling rotation speed, torsion and direction of rotation of the annular rotor 3. In addition, the annular rotor 3 and the annular stator 2 are constituted primarily by copper wires and silicon steel, which are very common materials and are much cheaper than rare earth, thereby reducing the production and manufacturing costs significantly. Furthermore, depending upon the structures of existing vehicles, the existing vehicles can be modified into the hybrid vehicles in a simplest and inexpensive way by just replacing the hub 11 of the existing vehicle, which is a very simplified installation method, thereby saving the huge cost of manufacturing or purchasing a new vehicle.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A hub power device of a hybrid vehicle, comprising:
a motor powered battery which is disposed in a vehicle body, whereas an accelerator unit in the vehicle receives operations to generate an accelerator signal;
an annular stator which is provided with a stator ring and plural stator coils wound on the stator ring, whereas the stator ring is fixed on the vehicle body and an axle shaft passes through the stator ring to be combined with a hub;
an annular rotor which is provided with a rotor ring and plural rotor coils wound on the rotor ring, whereas the rotor ring is fixed on an inner wall of the hub and is movably sheathed on an outer rim of the stator ring; and
a motor control unit which is disposed in the vehicle body and connects electrically the motor powered battery, the accelerator unit and the stator coils, with that the motor control unit receives the accelerator signal to control the motor powered battery to supply electric energy to the annular stator, thereby enabling the hub to spin following the annular rotor which is driven by the annular stator; if the accelerator unit not generating the accelerator signal and the annular rotor spinning following the hub, electric energy being generated between the annular rotor and the annular stator, whereas the motor control unit controlling electric energy of the annular stator to charge the motor powered battery.

2. The hub power device of a hybrid vehicle, according to claim 1, wherein the stator ring is made by silicon steel and is provided with a stator ring hole, with that the stator coils are wound alternately on the stator ring; the rotor ring being made by silicon steel and being provided with a rotor ring hole, with that the rotor coils are wound alternately on the rotor ring and the stator ring is disposed in the rotor ring hole.

3. The hub power device of a hybrid vehicle, according to claim 2, wherein the annular stator is provided with a stator coupling coil which connects electrically the stator coils, and the stator coupling coil is wound on the stator ring; the annular rotor being provided with a rotor coupling coil which connects electrically the rotor coils, and the rotor coupling coil being wound on the rotor ring at a location corresponding to the stator coupling coil; electric energy on the annular stator and the annular rotor being coupled together through the stator coupling coil and the rotor coupling coil, whereas the annular stator and the annular rotor constituting a DC (Direct Current) Brushless Cascade Motor.

4. The hub power device of a hybrid vehicle, according to claim 1, wherein the vehicle is an automobile or a motorcycle, whereas the stator ring is fixed on an on-board brake system and is disposed on the vehicle body.

5. The hub power device of a hybrid vehicle, according to claim 1, wherein the motor control unit connects electrically an on-board brake unit which links to an on-board brake system, the brake unit receives operations to generate a brake signal, and the motor control unit receives the brake signal to control the motor powered battery to stop supplying electric energy to the annular stator, thereby enabling the annular rotor to spin by inertia following the hub, and electric energy is generated between the annular rotor and the annular stator, whereas the motor control unit controls electric energy of the annular stator to charge the motor powered battery.

6. The hub power device of a hybrid vehicle, according to claim 1, wherein the motor control unit connects electrically an on-board gear position unit which links to an on-board transmission, with that the gear position unit receives operations to generate a gear position signal containing data of P gear, R gear, N gear or D gear; the motor control unit receiving the gear position signal to control the motor powered battery to stop supplying electric energy to the annular stator, thereby enabling the annular rotor to spin by inertia following the hub, and electric energy being generated between the annular rotor and the annular stator, whereas the motor control unit controlling electric energy of the annular stator to charge the motor powered battery when the gear position signal containing the data of P gear, R gear or N gear; the motor control unit controlling the motor powered battery to supply electric energy to the annular stator, thereby enabling the hub to spin following the annular rotor which is driven by the annular stator when the gear position signal containing the data of D gear.

7. The hub power device of a hybrid vehicle, according to claim 1, wherein the motor control unit connects electrically an on-board diagnostic system which monitors a status of an on-board engine to generate a diagnostic signal, whereas the motor control unit receives the diagnostic signal to determine when to turn on or off the motor powered battery to supply electric energy to the annular stator.

8. The hub power device of a hybrid vehicle, according to claim 1, wherein the motor control unit connects electrically a detection unit which is disposed on the annular stator, whereas the detection unit is used to detect an angle of the rotor and current of the coils; the detection unit detecting the annular stator to generate a detection signal which includes the angle of the rotor and the current of the coils, meanwhile the motor control unit receiving the detection signal to determine when to turn on or off the motor powered battery to supply electric energy to the annular stator.

9. The hub power device of a hybrid vehicle, according to claim 1, wherein the motor control unit includes a motor controller which connects electrically the accelerator unit, and a motor power controller which connects electrically the motor controller, the motor powered battery and the stator coils, thereby enabling the motor power controller controls the motor powered battery to supply electric energy to the annular stator when the motor control unit receives the accelerator signal.

10. The hub power device of a hybrid vehicle, according to claim 9, wherein the motor control unit includes a motor kinetic energy retriever which connects electrically the motor controller, the motor powered battery and the stator coils, thereby enabling the motor kinetic energy retriever controls electric energy of the annular stator to charge the motor powered battery if the motor controller does not receive the accelerator signal.

11. The hub power device of a hybrid vehicle, according to claim 9, wherein the motor control unit includes a motor powered battery boost charger which connects electrically the motor controller and the motor powered battery, whereas the motor powered battery boost charger connects electrically an on-board battery which links to an on-board generator, so that while the motor powered battery supplies electric energy to the annular stator, the motor controller enables the motor powered battery boost charger boosts up the on-board battery and charges the motor powered battery.
